(19) United States
(12) Patent Application Publication
(10) Pub. No.: US 2002/0163540 A1
(43) Pub. Date: Nov. 7, 2002

(54) GUI display processor

(75) Inventor: Mao Kishimoto, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/128,565

(22) Filed: Apr. 24, 2002

(30) Foreign Application Priority Data
May 1, 2001 (JP) 2001-133805

(51) Int. Cl. G09G 5/00

(52) U.S. Cl. 345/762; 345/748; 345/744; 345/778

(57) ABSTRACT

A screen determination unit acquires screen characteristic data corresponding to a characteristic and an operation mode of a screen display device, and on the basis of the screen characteristic data, specifies screen description data corresponding to a state of the screen display device in a screen description table stored in a screen description table storage unit. A screen display data setting unit sets screen display data on the basis of the specified screen description data. Therefore, GUIs (graphical user interfaces) can be displayed in a user friendly manner in accordance with the characteristic and the operation mode of equipment like a TV screen.

### BACKGROUND OF THE INVENTION

The present invention relates to technique for a display processor for realizing user friendly GUIs (graphical user interfaces) in displaying them on a screen of AV equipment such as a TV and a mobile telephone.

GUIs, which have a function to display graphics and allow equipment to interact with its user on a screen of not only a personal computer but also AV equipment such as a TV, a mobile telephone and a car navigation system, have recently spread. In such user interfaces, for displaying a variety of GUI components on the screen, the arrangement of the GUI components to be displayed is conventionally determined uniquely with respect to each product of the various equipment using the user interfaces.

Also, for verifying the GUIs by using a simulator, the simulator is conventionally prepared with respect to each product of the various equipment.

However, since the screen size, the number of pixels and the sizes of the GUI components are not considered in displaying the GUIs, a GUI screen serving as a good user interface cannot be provided to a user at present.

Specifically, in taking a TV as an example, in the case where a GUI screen for an aspect ratio of, for example, 4:3 is prepared, the GUI screen for an aspect ratio of 4:3 is enlarged in displaying it on a screen with an aspect ratio of 16:9. Also, the same GUI screen is used for a 14-inch screen and a 29-inch screen. In this manner, even when the aspect ratio is changed or the screen size is different, the same GUI screen is used or a prepared GUI screen is enlarged. Therefore, a GUI screen cannot be appropriately displayed in accordance with the state of the display screen. Furthermore, when the number of pixels is different, it is necessary to prepare different GUI screens depending upon the number of pixels.

Also, in the case where GUIs are verified by using a simulator, it is necessary to prepare different simulators depending upon the aspect ratio, the screen size and the number of pixels.

### SUMMARY OF THE INVENTION

According to the present invention, GUIs are not displayed in the same manner in the same product, but if the characteristic of a display screen such as the screen size and the number of pixels is different or the operation mode such as a full-screen display mode and a 4:3 display mode in a TV with a 16:9 screen is different, a GUI screen is controlled to display GUIs in accordance with the characteristic and the operation mode. Specifically, an object of the invention is displaying GUIs serving as a good user interface by changing the structure of an optimal GUI screen in accordance with the characteristic and the operation mode of equipment using the GUIs.

Another object of the invention is, in verifying GUIs by using a simulator, realizing efficient verification of GUIs in which a GUI designer need not manually change the simulator in accordance with the characteristic of equipment such as the screen size and the number of pixels and the operation mode such as the full-screen display mode and the 4:3 display mode in a TV with a 16:9 screen.

Specifically, the display processor of this invention includes a screen display device for displaying graphics of GUIs; a screen description table storage unit for storing a screen description table describing a displayable state corresponding to a characteristic and an operation mode of the screen display device; a screen determination unit for acquiring screen characteristic data corresponding to the characteristic and the operation mode of the screen display device from the screen display device and, on the basis of the screen characteristic data, specifying, in the screen description table stored in the screen description table storage unit, screen description data corresponding to a state of the screen display device; and a screen display data setting unit for setting, on the basis of the screen description data specified by the screen determination unit, screen display data to be displayed in the screen display device.

In this display processor, the screen determination unit acquires, from the screen display device, the screen characteristic data corresponding to the characteristic and the operation mode of the screen display device, and on the basis of the screen characteristic data, specifies the screen description data corresponding to the state of the screen display device in the screen description table. Then, the screen display data setting unit sets the screen display data on the basis of the screen description data corresponding to the state of the screen display device. Since a GUI screen is thus controlled in accordance with the characteristic and the operation mode of the equipment using GUIs, the user friendly GUIs serving as a good user interface can be displayed.

Preferably, the display processor further includes a screen information setting device for externally changing the characteristic and the operation mode of the screen display device, and the screen determination unit acquires screen characteristic data corresponding to a characteristic and an operation mode of the screen display device having been changed by the screen information setting device and newly specifies screen description data corresponding to a state of the screen display device.

Preferably, the display processor further includes a GUI data storage unit for storing GUI component data used for screen display of the screen display device, and the screen display data setting unit sets the screen display data on the basis of the GUI component data stored in the GUI data storage unit.

In the display processor, the screen description table storage unit preferably has a structure in which the screen description table is updatable through an external unit such as a network or a satellite data receiver.

In the display processor, the screen display data setting unit preferably has a structure in which an operation specification thereof is updatable through an external unit such as a network or a satellite data receiver.

In the display processor, the screen information setting device preferably has a structure in which an operation specification thereof is updatable through an external unit such as a network or a satellite data receiver.

In the display processor, the GUI data storage unit preferably has a structure in which the GUI component data is updatable through an external unit such as a network or a satellite data receiver.

In the display processor, it is preferred that the screen display data setting unit inputs the screen display data to a screen display simulator for verifying the GUIs, and that the screen display simulator switches a screen display mode thereof in accordance with the screen display data. In this manner, the screen display simulator receives, as an input, the screen display data set by the screen display data setting unit, so as to switch its own screen display mode corresponding to the screen size and the number of pixels employed for display. Therefore, there is no need for a GUI designer to manually change a simulator in accordance with the characteristic and the operation mode of equipment using GUIs, so that the GUIs can be efficiently verified.

### BRIEF DESCRIPTION OF THE DRAWINGS

FIG. 1 is a block diagram for showing the structure of a display processor according to Embodiment 1 of the invention;

FIG. 2 is an example of a screen description table stored in a screen description table storage unit according to each embodiment of the invention;

FIG. 3 is a flowchart for an operation of the display processor according to each embodiment of the invention;

FIG. 4 is a flowchart for timing of screen information setting in the display processor of each embodiment of the invention;

FIG. 5 shows examples of GUI components stored in a GUI storage unit according to Embodiment 1 of the invention;

FIGS. 6A, 6B, 7A and 7B show examples of a screen image output to a screen display device or a screen display simulator according to Embodiment 1 of the invention;

FIG. 8 is a block diagram for showing the structure of a display processor according to Embodiment 2 of the invention;

FIG. 9 shows an example of GUI components stored in a GUI storage unit according to Embodiment 2 of the invention;

FIGS. 10A, 10B, 11A and 11B show examples of a screen image output to a screen display device or a screen display simulator according to Embodiment 2 of the invention; and

FIG. 12 is a block diagram for showing the structure of a display processor according to Embodiment 3 of the invention.

### DETAILED DESCRIPTION OF THE INVENTION

Preferred embodiments of the invention will now be described with reference to the accompanying drawings.

EMBODIMENT 1

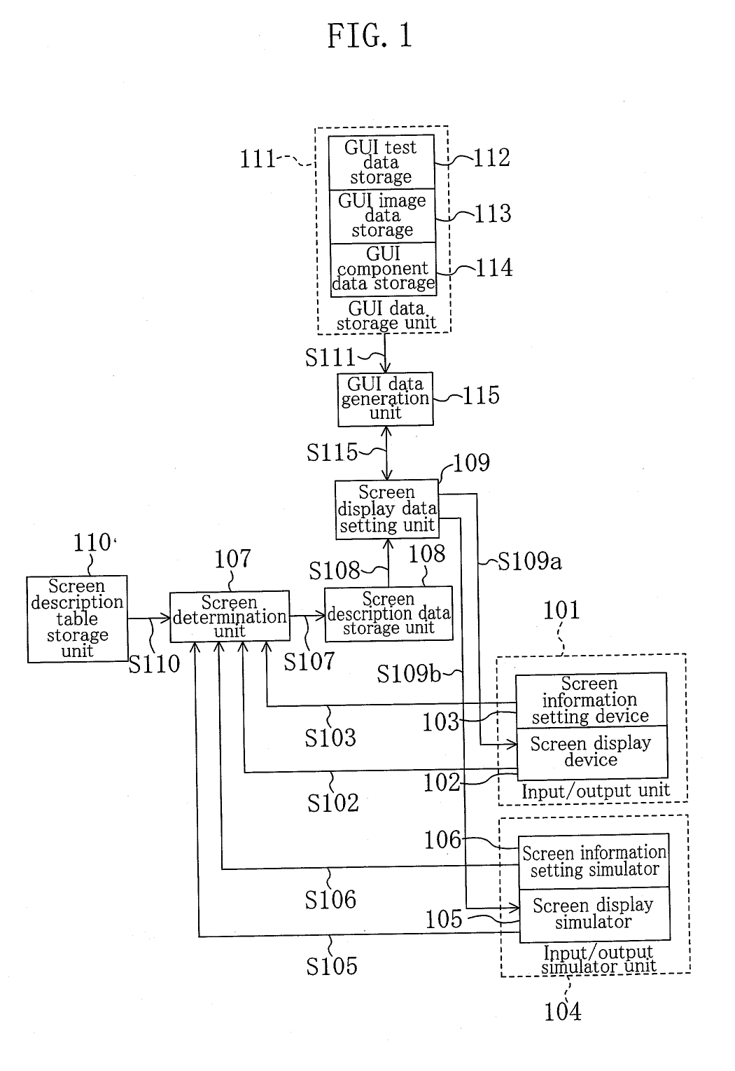

Embodiment 1 of the invention will be described with reference to FIGS. 1 through 7B.

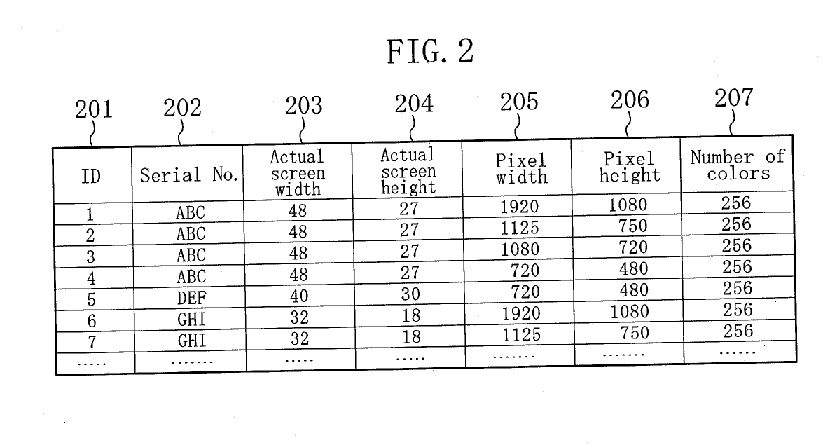

FIG. 1 is a block diagram for showing the structure of a display processor of Embodiment 1, and FIG. 2 is a diagram of an example of a screen description table. The other drawings mentioned above will be described later.

The display processor of FIG. 1 includes an input/output unit 101, an input/output simulator unit 104, a screen determination unit 107, a screen description data storage unit 108, a screen display data setting unit 109, a screen description table storage unit 110, a GUI data storage unit 111 and a GUI data generation unit 115.

The input/output unit 101 for performing screen display and screen setting includes a screen display device, 102 and a screen information setting device 103.

The screen display device 102 displays graphics of GUIs and has a peculiar value in accordance with, for example, HDTV compatibility and the aspect ratio. Also, the screen display device 102 receives screen display data S109a as an input so as to display the screen display data S109a on a screen, and outputs screen characteristic data S102 corresponding to the number of pixels to the screen determination unit 107.

The screen information setting device 103 externally changes the characteristic of the screen display device 102 such as the screen size and the number of pixels and the operation mode thereof such as the full-screen display mode and the 4:3 display mode in a TV with a 16:9 screen. Also, the screen information setting device 103 outputs, to the screen determination unit 107, screen characteristic data S103 corresponding to the number of pixels and the aspect ratio having been changed by, for example, a user with the screen information setting device 103.

The input/output simulator unit 104 simulates, on a computer, devices for screen display and screen setting. Specifically, this is used in verifying input/output on a computer without using an actual simulator. The input/output simulator unit 104 includes a screen display simulator 105 and a screen information setting simulator 106.

The screen display simulator 105 for displaying graphics of GUIs has a peculiar value in accordance with, for example, HDTV compatibility and the aspect ratio. Also, the screen display simulator 105 receives, as an input, screen display data S109b and switches, on the basis of the screen display data S109b, its screen display mode corresponding to the screen size and the number of pixels employed in the screen display. Furthermore, the screen display simulator 105 outputs screen characteristic data S105 corresponding to the number of pixels to the screen determination unit 107.

The screen information setting simulator 106 externally changes the characteristic such as the screen size and the number of pixels of the screen display device 102 and the operation mode such as the full-screen display mode and the 4:3 display mode in a TV with a 16:9 screen. Also, the screen information setting simulator 106 outputs, to the screen determination unit 107, screen characteristic data S106 corresponding to the number of pixels and the aspect ratio having been changed by, for example, a user with the screen information setting simulator 106.

The screen determination unit 107 acquires the screen characteristic data S102 or S105 corresponding to the characteristic and the operation mode of the screen display device 102 or the screen display simulator 105, for example, the characteristic such as the screen size and the number of pixels or the operation mode such as the 4:3 display mode, the full-screen display mode and a movie display mode. Also, the screen determination unit 107 acquires, from the screen description table storage unit 110, data S110 described in a screen description table, and determines, on the basis of the screen characteristic data S102 or S105, the characteristic and the operation mode of the screen display device 102. As a result, it generates screen description data S107 to be output to the screen description data storage unit 108. Although the screen description data S107 is herein output to the screen description data storage unit 108, the display processor of this invention can be similarly realized without providing the screen description data storage unit 108 with the screen description data S107 directly output to the screen display data setting unit 109.

The screen description data storage unit 108 stores the screen description data S107 specified by the screen determination unit 107. Also, the screen description data storage unit 108 outputs screen description data S108 (having the same content as the screen description data S107) stored therein to the screen display data setting unit 109. The screen description data S108 may have been changed in accordance with a change request issued by the screen information setting device 103 or the screen information setting simulator 106.

The screen display data setting unit 109 receives, as inputs, not only the screen description data S108 stored in the screen description data storage unit 108 but also GUI data S115 generated by the GUI data generation unit 115, and generates the screen display data S109a or S109b to be output to the screen display device 102 or the screen display simulator 105 by selecting, enlarging or reducing GUI components on the basis of the screen description data S108 and the GUI data S115. The screen display data S109a or S109b is output to the screen display device 102 or the screen display simulator 105, respectively. The GUI data S115 input to the screen display data setting unit 109 may be acquired from the GUI data generation unit 115 or GUI component data S111 may be directly acquired from the GUI data storage unit 111 as the GUI data S115.

The screen description table storage unit 110 stores the data S110 described in the screen description table of FIG. 2. In other words, the screen description table storage unit 110 stores the data S110 corresponding to a displayable state corresponding to the characteristic and the operation mode of the screen display device 102 or the screen display simulator 105 and outputs the data S110 to the screen determination unit 107.

The GUI data storage unit 111 stores the GUI component data S111, that is, data necessary for generating the screen display data S109a or S109b to be displayed in the screen display device 102 or the screen display simulator 105. The GUI data storage unit 111 includes a GUI text data storage 112, a GUI image data storage 113 and a GUI component data storage 114. The GUI text data storage 112 stores text data used for forming GUIs. The GUI image data storage 113 stores images including still images such as a bit map and dynamic images used for forming GUIs. The GUI component data storage 114 stores components used for forming GUIs.

The GUI data generation unit 115 acquires, as inputs, the GUI component data S111 stored in the GUI text data storage 112, the GUI image data storage 113 and the GUI component data storage 114 of the GUI storage unit 111. Also, the GUI data generation unit 115 generates respective GUI components necessary for generating the screen display data S109a or S109b in the screen display data setting unit 109 and outputs the generated GUI components to the screen display data setting unit 109 as the GUI data S115.

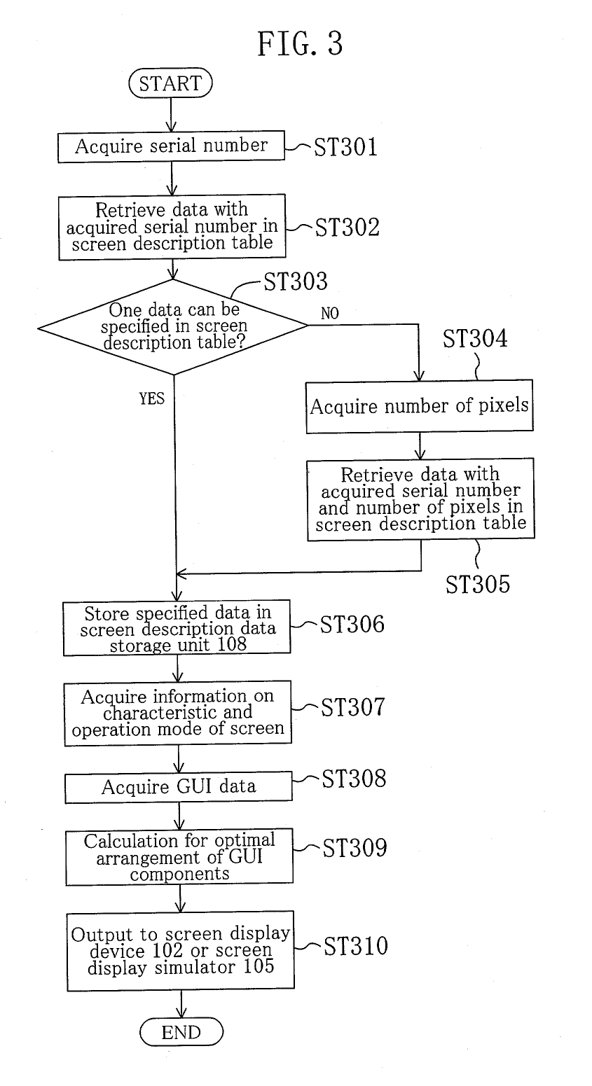

Now, the operation of the display processor of this embodiment having the aforementioned structure will be described with reference to FIG. 3. FIG. 3 is a flowchart for the operation of the display processor of FIG. 1.

First, in step ST301, the screen determination unit 107 acquires information on a serial number as the screen characteristic data S102 or S105 of the screen display device 102 or the screen display simulator 105. Then, in step ST302, the screen determination unit 107 compares the information acquired in step ST301 with the data S110 described in the screen description table stored in the screen description table storage unit 110, so as to retrieve data having the same serial number. In step ST303, it is determined whether or not the retrieved data can be specified to one.

When the retrieved data can be specified to one in step ST303, the procedure proceeds to step ST306. On the other hand, when the retrieved data cannot be specified to one, the screen determination unit 107 acquires, in step ST304, the screen characteristic data S102 or S105 corresponding to the number of pixels from the screen display device 102 or the screen display simulator 105. Thereafter, in step ST305, the screen determination unit 107 compares the information acquired in step ST301 and the information acquired in step ST304 with the data S110 described in the screen description table. In this manner, data having the same serial number and the same number of pixels is retrieved so as to specify one data in the data S110, and the procedure proceeds to step ST306.

In step ST306, the screen description data S107 specified by the screen determination unit 107 is stored in the screen description data storage unit 108, and the procedure proceeds to step ST307.

In step ST307, the screen display data setting unit 109 acquires the screen description data S108 from the screen description data storage unit 108. At this point, the screen description data S108 stored in the screen description data storage unit 108 may have been updated in steps ST401 and ST402 described below.

In step ST308, the screen display data setting unit 109 acquires the GUI data S115 from the GUI data generation unit 115 storing the GUI data S115 necessary for generating the screen display data S109a or S109b to be displayed in the screen display device 102 or the screen display simulator 105, and the procedure proceeds to step ST309. Although the screen display data setting unit 109 herein acquires the GUI data S115 from the GUI data generation unit 115, the GUI component data S111 may be directly acquired from the GUI data storage unit 111 as the GUI data S115.

In step ST309, the screen display data setting unit 109 generates the screen display data S109a or S109b by performing calculation based on the acquired screen description data S108 and GUI data S115 so as to obtain optimal arrangement of GUI components (whereas a specific method for generating the screen display data will be described later). Thereafter, in step ST310, the generated screen display data S109a or S109b is output to the screen display device 102 or the screen display simulator 105, respectively. On the basis of the input screen display data S109a, the screen display device 102 displays graphics of GUIs. Also, on the basis of the input screen display data S109b, the screen display simulator 105 switches its own screen display mode.

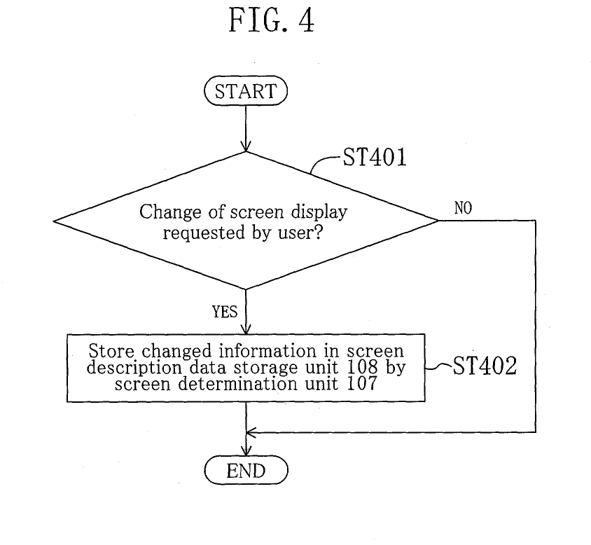

Next, the operation performed in the case where the screen description data S108 stored in the screen description data storage unit 108 is updated will be described with reference to FIG. 4. FIG. 4 is a flowchart for timing for screen information setting in the display processor of this invention.

In step ST401, it is determined whether or not a user requests to change the characteristic and the operation mode of the screen display device 102 or the screen display simulator 105 by using the screen information setting device 103 or the screen information setting simulator 106.

When there is a change request, the screen determination unit 107 stores, in step ST402, information on the changed characteristic and operation mode of the screen display device 102 or the screen display simulator 105 in the screen description data storage unit 108. Therefore, the screen description data S108 stored in the screen description data storage unit 108 is updated. When there is no change request, the screen description data S108 stored in the screen description data storage unit 108 is not updated.

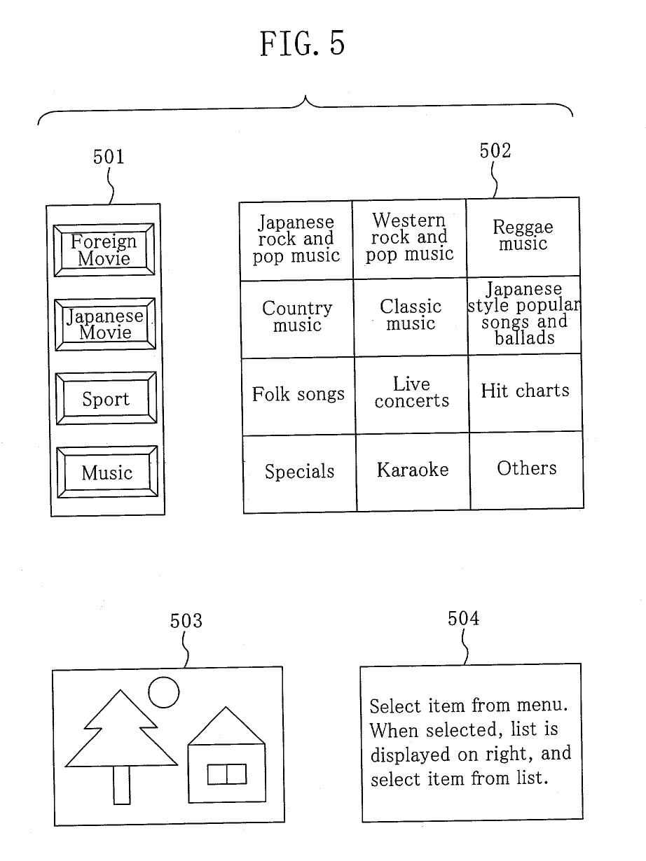

Specific examples of the operation of the display processor having the aforementioned structure will now be described with reference to FIGS. 5, 6A, 6B, 7A and 7B.

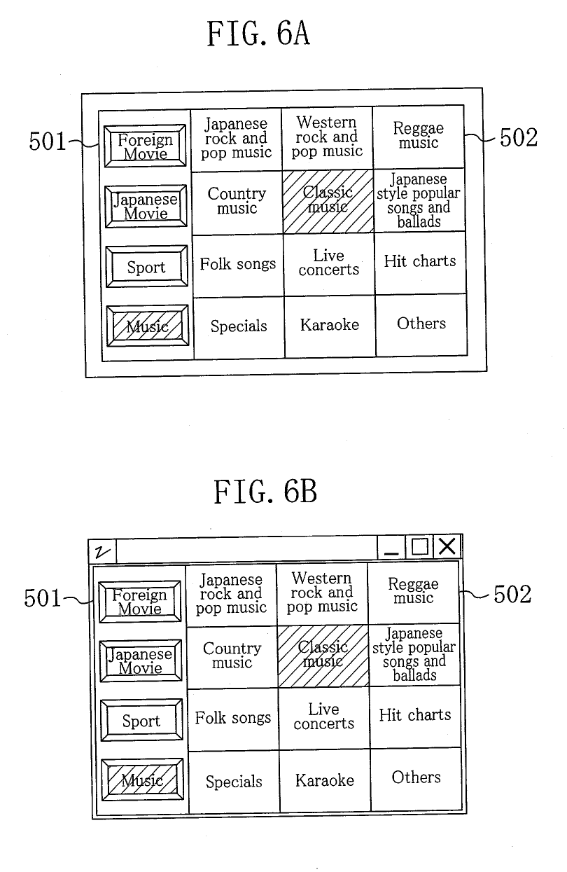

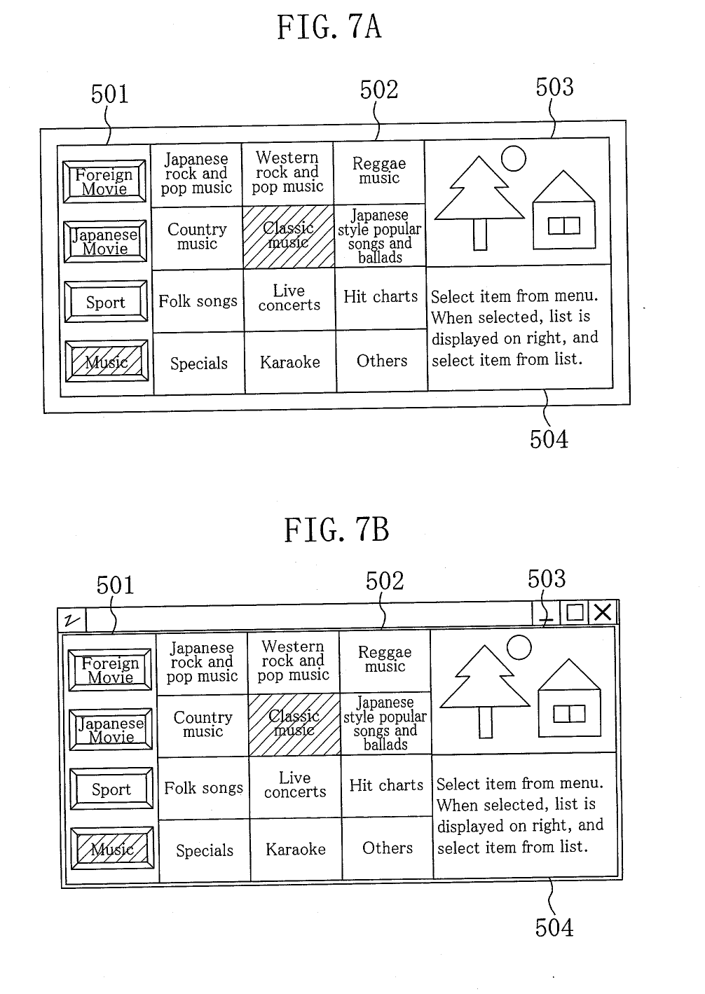

FIG. 5 shows examples of GUI components generated by the GUI data generation unit 115 on the basis of a variety of GUI data stored in the GUI data storage unit 111. FIGS. 6A and 7A show examples of a screen image output to the screen display device 102, and FIGS. 6B and 7B show examples of a screen image output to the screen display simulator 105.

The following description is given in assuming that the input/output unit 101 is a TV.

Herein, assuming that a menu 501, a list 502, an image box 503 and a text box 504 are generated as GUI components to be displayed in the screen display device 102, GUIs are displayed in the screen display device 102 in the following manner. It is noted that data necessary for generating the GUI components such as the menu 501 are stored in the GUI data storage unit 111.

First, in the case where the TV has a 4:3 screen, the image processor is operated as follows:

In this case, the screen determination unit 107 acquires a serial number “DEF” corresponding to the characteristic of the screen display device 102 (step ST301). Then, the screen determination unit 107 compares the serial number with the data S110 described in the screen description table so as to retrieve data having the same serial number (step ST302). It is then determined whether or not the retrieved data can be specified to one, and in this case, referring to serial numbers (202) of FIG. 2, the data having the serial number “DEF” can be specified to one (YES in step ST303).

Accordingly, the screen determination unit 107 stores, in the screen description data storage unit 108, one screen description data S107 having “an ID (201) of 5, an actual screen width (203) of 40, an actual screen height (204) of 30, a pixel width (205) of 720, a pixel height (206) of 480 and a number of colors (207) of 256” specified in the data S110 shown in FIG. 2 (step ST306). Thereafter, the screen display data setting unit 109 acquires the screen description data S108 from the screen description data storage unit 108 (step ST307). Furthermore, the screen display data setting unit 109 acquires the GUI data S115 from the GUI data generation unit 115. Specifically, in this example, assuming that the four GUI components, that is, the menu 501 having a size of 180×480 pixels, the list 502 having a size of 540×480 pixels, the image box 503 having an arbitrary size of approximately 360×360 pixels and the text box 504 having an arbitrary size of approximately 360×360 pixels, are to be displayed, the screen display data setting unit 109 acquires these data (step ST308).

Then, the screen display data setting unit 109 generates the screen display data S109a by performing calculation on the basis of the acquired screen description data S108 and GUI data S115 so as to obtain optimal arrangement of the GUI components. Specifically, since the pixel width is 720 and the pixel height is 480 in this example, it is determined that the menu 501 and the list 502 alone can be displayed (step ST309). Accordingly, the screen display data S109a as shown in FIG. 6A is output to the screen display device 102 (step ST310).

In the case where the input/output unit 101, the screen display device 102 and the screen information setting device 103 are respectively replaced with the input/output simulator unit 104, the screen display simulator 105 and the screen information setting simulator 106, the screen display data S109b as shown in FIG. 6B can be output to the screen display simulator 105 in the same manner. Also in this case, the screen display simulator 105 switches its own screen display mode so that a GUI screen with a size of 720×480 pixels can be displayed.

Next, in the case where the TV has a 16:9 screen, the display processor is operated as follows:

In this case, the screen determination unit 107 acquires a serial number “ABC” corresponding to the characteristic of the screen display device 102 (step ST301). Thereafter, the screen determination unit 107 compares the serial number with the data S110 described in the screen description table so as to retrieve data having the same serial number (step ST302). Then, it is determined whether or not the retrieved data can be specified to one, and in this case, referring to the serial numbers (202) of FIG. 2, there are four data having the serial number “ABC”, and hence the retrieved data cannot be specified to one (NO in step ST303). Therefore, the screen determination unit 107 further acquires the screen characteristic data S102 corresponding to the number of pixels from the screen display device 102 (step ST304). The acquired screen characteristic data S102 corresponding to the number of pixels is compared with the data S110 described in the screen description table for retrieval. If the screen display device 102 has 1080×720 pixels, one screen description data S107 having “an ID (201) of 3, an actual screen width (203) of 48, an actual screen height (204) of 27, a pixel width (205) of 108, a pixel height (206) of 720 and a number of colors (207) of 256” shown in FIG. 2 can be specified in the data S110 (step ST305), and the screen determination unit 107 stores this screen description data S107 in the screen description data storage unit 108 (step ST306).

Thereafter, the screen display data setting unit 109 acquires the screen description data S108 from the screen description data storage unit 108 (step ST307). Furthermore, the screen display data setting unit 109 acquires the GUI data S115 from the GUI data generation unit 115. Specifically, also in this example, assuming that the four GUI components, that is, the menu 501 having a size of 180×480 pixels, the list 502 having a size of 540×480 pixels, the image box 503 having an arbitrary size of approximately 360×360 pixels and the text box 504 having an arbitrary size of approximately 360×360 pixels, are to be displayed, the screen display data setting unit 109 acquires these data (step ST308).

Then, the screen display data setting unit 109 generates the screen display data S109a by performing calculation on the basis of the acquired screen description data S108 and GUI data S115 so as to obtain optimal arrangement of the GUI components. Specifically, since the pixel width is 1080 and the pixel height is 720 in this example, it is determined that the menu 501, the list 502, the image box 503 and the text box 504 can be displayed (step ST309). Accordingly, the screen display data S109a as shown in FIG. 7A is output to the screen display device 102 (step ST310).

In the case where the input/output unit 101, the screen display device 102 and the screen information setting device 103 are respectively replaced with the input/output simulator unit 104, the screen display simulator 105 and the screen information setting simulator 106, the screen display data S109b as shown in FIG. 7B can be output to the screen display simulator 105 in the same manner. Also in this case, the screen display simulator 105 switches its own screen display mode, so that a GUI screen with a size of 1080×720 pixels can be displayed.

Now, how the screen display data setting unit 109 generates the screen display data S109a or S109b through calculation for obtaining optimal arrangement of the GUI components will be described.

It is set forth as a premise that the number of kinds of GUI components included in the GUI data S115 (or the GUI component data S111) input to the screen display data setting unit 109 is infinite and that the size of one GUI component is frequently not fixed because it may be enlarged or reduced.

First, a region for arranging the GUI components is set. In the examples shown in FIGS. 5 through 7B, the GUI components are set to be successively arranged along the rightward direction. In this case, for example, in FIG. 5, it is set to successively arrange the menu 501, the list 502, the image box 503 and the text box 504 in this order along the rightward direction. In other words, this order corresponds to the priority in displaying the GUI components and this means that, in FIG. 5, the GUI components are preferentially displayed in the order from the menu 501 and omitted in the order from the text box 504 depending upon the screen size. Also, it is previously set that no GUI components can be arranged above and below the menu 501 and the list 502 but some GUI components may be arranged above and below the image box 503 and the text box 504.

After setting the region for arranging the GUI components in this manner, in the case where a region for displaying the GUI components (hereinafter referred to as the “display region”) has a fixed size (for example, determined by an application developer), it can be determined which GUI components are arranged on the basis of the screen description data S108 stored in the screen description data storage unit 108 and the GUI data S115, so as to generate the screen display data S109a or S109b. Specifically, the GUI components are successively arranged along the rightward direction so as to generate the screen display data S109a or S109b shown in FIGS. 6A and 7A or 6B and 7B. At this point, when the display region is smaller than the GUI components, the screen display data S109a or S109b is generated by omitting any of GUI components to be displayed, changing the font size or reducing the sizes of the GUI components to be displayed. On the other hand, when the display region is larger than the GUI components, the screen display data S109a or S109b is generated by changing the font size or enlarging the sizes of the GUI components to be displayed.

In the case where the display region does not have a fixed size, since the sizes of the GUI components are variable, the maximum and minimum sizes of each GUI component are previously stored. In this case, the screen display data S109a or S109b is generated, for example, as follows: The GUI components are arranged in the region set for arranging them on the basis of the minimum sizes of the GUI components. If there remains any room, any GUI component that can be enlarged is enlarged on the basis of GUI component enlargement priority (which is previously set and means priority in determining which GUI component is preferentially arranged). Thus, the screen display data S109a or S109b is generated.

Although the GUI components are successively arranged along the rightward direction after setting the region for arranging the GUI components in this embodiment, the arranging direction is not limited to the rightward direction but may be set to any direction including the downward direction, the upward direction, the rightward direction and the leftward direction. Furthermore, in the case where the region for arranging the GUI components is not set, the screen display data S109a or S109b may be generated as follows: Among the GUI components (having the minimum size if they have a changeable size), merely those that can be arranged are randomly arranged, and then, if there is any space therebetween, the arranged GUI components are enlarged to reduce the space.

In this manner, according to this embodiment, the screen determination unit acquires information on a serial number of the screen display device, so as to specify screen description data corresponding to the state of the screen display device in the data described in the screen description table. Then, the screen display data setting unit generates screen display data on the basis of the specified screen description data and GUI data acquired from the GUI data generation unit. Thus, a GUI screen is controlled, for example, by selecting GUI components and changing their sizes, in accordance with not only the type of equipment but also change of the characteristic and the operation mode in one equipment. Accordingly, it is possible to display user friendly GUIs serving as a good user interface.

Also, according to this embodiment, the screen display simulator switches its own screen display mode when the screen display data is output to the screen display simulator. Therefore, there is no need for a GUI designer to manually change the simulator in accordance with the characteristic and the operation mode of equipment using the GUIs, and hence, the GUIs can be efficiently verified.

EMBODIMENT 2

Embodiment 2 of the invention will now be described with reference to FIGS. 2, 3 and 8 through 11B.

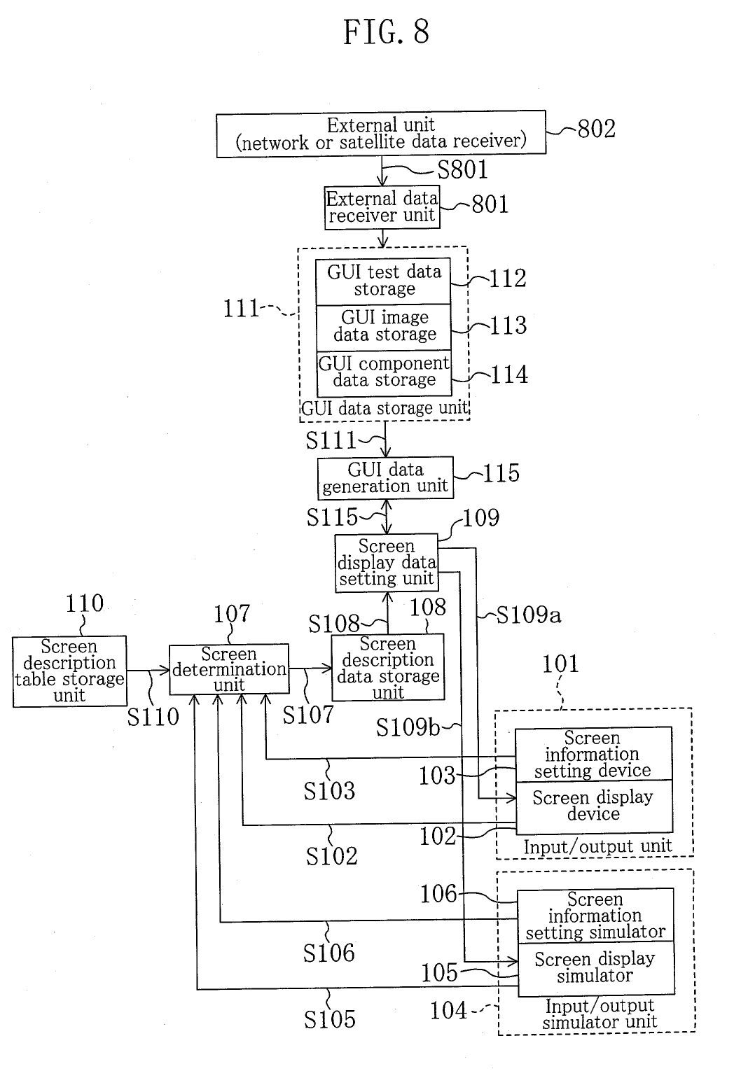

FIG. 8 is a block diagram for showing the structure of a display processor according to Embodiment 2 of the invention. In FIG. 8, like reference numerals are used to refer to like elements shown in FIG. 1 so as to omit the detailed description. This display processor is different from that of FIG. 1 in including an external data receiver unit 801 and an external unit 802. The other drawings mentioned above will be described later.

The external data receiver unit 801 receives GUI data S801 sent by using the external unit 802 such as a network or a satellite data receiver, processes the received data if necessary and outputs them to the GUI data storage unit 111.

The external unit 802 is a network, a satellite data receiver or the like for sending the various GUI data S801 to the external data receiver unit 801.

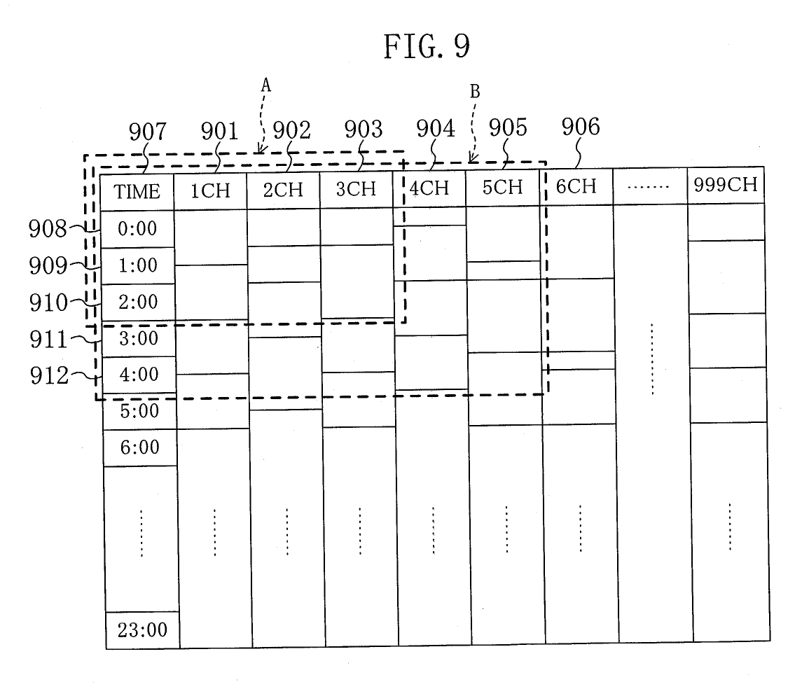

Specific examples of the operation of the display processor having the aforementioned structure will now be described with reference to FIGS. 9, 10A, 10B, 11A and 11B.

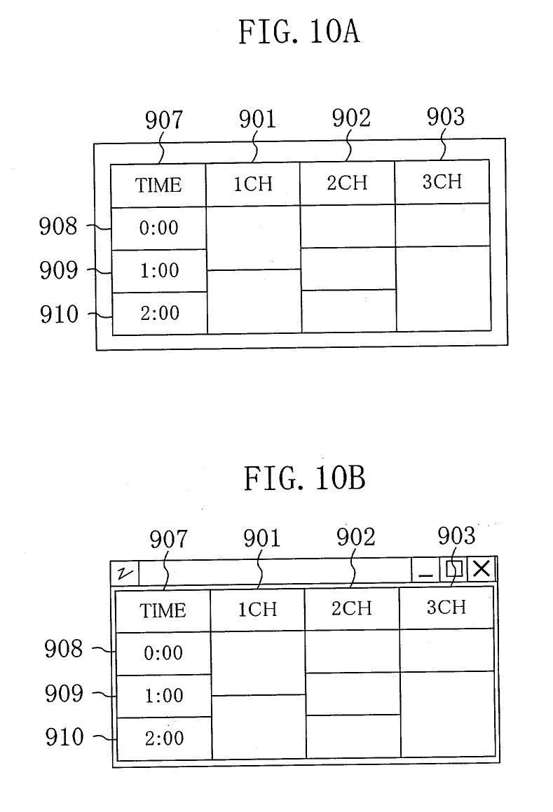

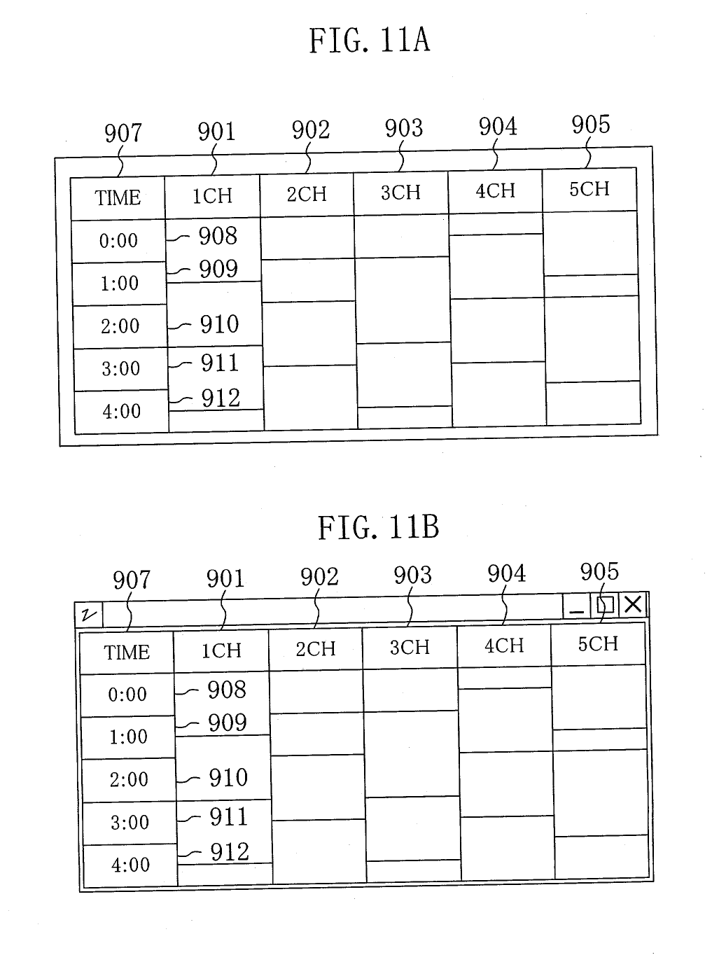

FIG. 9 shows an example of a GUI component generated by the GUI data generation unit 115 on the basis of the various GUI data S111 sent from the external unit 802 through the external data receiver unit 801 and stored in the GUI data storage unit 111. Also, FIGS. 10A and 11A show examples of a screen image output to the screen display device 102 and FIGS. 10B and 11B show examples of a screen image output to the screen display simulator 105.

The following description is given in assuming that the input/output unit 101 is a TV.

Herein, assuming that an electronic program guide as shown in FIG. 9 is generated as a GUI component to be displayed in the screen display device 102 on the basis of data input from the external unit 802 through the external data receiver unit 801 such as a network or a satellite data receiver, the electronic program guide is displayed in the screen display device 102 in the following manner. Data necessary for generating the electronic program guide are stored in the GUI data storage unit 111 after acquiring from the external unit 802 through the external data receiver unit 801 such as a transport decoder.

First, in the case where the TV has a 4:3 screen, the display processor is operated as follows:

In this case, the screen determination unit 107 acquires a serial number “DEF” corresponding to the characteristic of the screen display device 102 (step ST301). Then, the screen determination unit 107 compares the serial number with the data S110 described in the screen description table, so as to retrieve data having the same serial number (step ST302). Thereafter, it is determined whether or not the retrieved data can be specified to one, and in this case, referring to the serial numbers (202) of FIG. 2, the data having the serial number “DEF” can be specified to one (YES in step ST303).

Accordingly, the screen determination unit 107 stores, in the screen description data storage unit 108, one screen description data S107 having “an ID (201) of 5, an actual screen width (203) of 40, an actual screen height (204) of 30, a pixel width (205) of 720, a pixel height (206) of 480 and a number of colors (207) of 256” specified in the data S110 shown in FIG. 2 (step ST306). Thereafter, the screen display data setting unit 109 acquires the screen description data S108 from the screen description data storage unit 108 (step ST307). Furthermore, the screen display data setting unit 109 acquires the GUI data S115 from the GUI data generation unit 115. Specifically, in this example, assuming that the GUI component to be displayed is the electronic program guide having a lateral dimension of 180 pixels for displaying a time axis (907) and each channel (901, 902, 903, 904, 905 or 906) and a vertical dimension of 120 pixels for displaying channel information and program information of each hour (908, 909, 910, 911 or 912), the screen display data setting unit 109 acquires these data (step ST308).

The screen display data setting unit 109 generates the screen display data S109a by performing calculation on the basis of the acquired screen description data S108 and GUI data S115 so as to obtain optimal arrangement of the GUI component. Specifically, since the pixel width is 720 and the pixel height is 480 in this example, the time axis (907) and three channels (901 through 903) can be displayed and the channel information and the program information of 3 hours (908 through 910) can be displayed (step ST309). Therefore, the screen display data S109a as shown in FIG. 10A corresponding to an area A of FIG. 9 is output to the screen display device 102 (step ST310).

In the case where the input/output unit 101, the screen display device 102 and the screen information setting device 103 are respectively replaced with the input/output simulator unit 104, the screen display simulator 105 and the screen information setting simulator 106, the screen display data S109b as shown in FIG. 10B corresponding to the area A of FIG. 9 can be output to the screen display simulator 105 in the same manner. Also in this case, the screen display simulator 105 switches its own screen display mode so that a GUI screen with a size of 720×480 pixels can be displayed.

Next, in the case where the TV has a 16:9 screen, the display processor is operated as follows:

In this case, the screen determination unit 107 acquires a serial number “ABC” corresponding to the characteristic of the screen display device 102 (step ST301). Thereafter, the screen determination unit 107 compares the serial number with the data S110 described in the screen description table so as to retrieve data having the same serial number (step ST302). Then, it is determined whether or not the retrieved data can be specified to one, and in this case, referring to the serial numbers (202) of FIG. 2, there are four data having the serial number “ABC”, and hence the retrieved data cannot be specified to one (NO in step ST303). Therefore, the screen determination unit 107 further acquires the screen characteristic data S102 corresponding to the number of pixels from the screen display device 102 (step ST304). The acquired screen characteristic data S102 corresponding to the number of pixels is compared with the data S110 described in the screen description table for retrieval. Assuming that the screen display device 102 has 1080×720 pixels, one screen description data S107 having “an ID (201) of 3, an actual screen width (203) of 48, an actual screen height (204) of 27, a pixel width (205) of 108, a pixel height (206) of 720 and a number of colors (207) of 256” can be specified in the data S110 shown in FIG. 2 (step ST305), and the screen determination unit 107 stores this screen description data S107 in the screen description data storage unit 108 (step ST306).

At this point, if change of screen information is requested by the screen information setting device 103 (step ST401), namely, if the screen information setting device 103 requests, for example, to display the GUI component in a 4:3 area on the 16:9 screen of the TV, the screen determination unit 107 performs calculation on the basis of the data S110 described in the screen description table and the screen characteristic data S103, so as to specify one screen description data S107 having “an ID (201) of 4, an actual screen width (203) of 36 (=27÷3×4), an actual screen height (204) of 27, a pixel width (205) of 720, a pixel height (206) of 480 and a number of colors (207) of 256”. Then, the screen determination unit 107 stores this screen description data S107 in the screen description data storage unit 108 (step ST402).

Thereafter, the screen display data setting unit 109 acquires the screen description data S108 from the screen description data storage unit 108 (step ST307). Furthermore, the screen display data setting unit 109 acquires the GUI data S115 from the GUI data generation unit 115. Specifically, also in this example, assuming that the GUI component to be displayed is the electronic program guide having a lateral dimension of 180 pixels for displaying a time axis (907) and each channel (901, 902, 903, 904, 905 or 906) and a vertical dimension of 120 pixels for displaying channel information and program information of each hour (908, 909, 910, 911 or 912), the screen display data setting unit 109 acquires these data (step ST308).

The screen display data setting unit 109 generates the screen display data S109a by performing calculation on the basis of the acquired screen description data S108 and GUI data S115 so as to obtain optimal arrangement of the GUI component. Specifically, since the pixel width is 1080 and the pixel height is 720 in this example, the time axis (907) and five channels (901 through 905) can be displayed and the channel information and the program information of 5 hours (908 through 912) can be displayed (step ST309). Therefore, the screen display data S109a as shown in FIG. 11A corresponding to an area B of FIG. 9 is output to the screen display device 102 (step ST310).

In the case where the input/output unit 101, the screen display device 102 and the screen information setting device 103 are respectively replaced with the input/output simulator unit 104, the screen display simulator 105 and the screen information setting simulator 106, the screen display data S109b as shown in FIG. 11B corresponding to the area B of FIG. 9 can be output to the screen display simulator 105 in the same manner. Also in this case, the screen display simulator 105 switches its own screen display mode so that a GUI screen with a size of 1080×720 pixels can be displayed.

In this manner, according to this embodiment, information on text data, image data and component data for GUIs are newly acquired from the external unit such as a network or a satellite data receiver. Accordingly, on the basis of the new GUI data, a GUI screen can be controlled by, for example, selecting GUI components and changing the sizes thereof in accordance with the characteristic and the operation mode of the equipment using the GUIs. As a result, more user friendly GUIs serving as a good user interface can be displayed.

EMBODIMENT 3

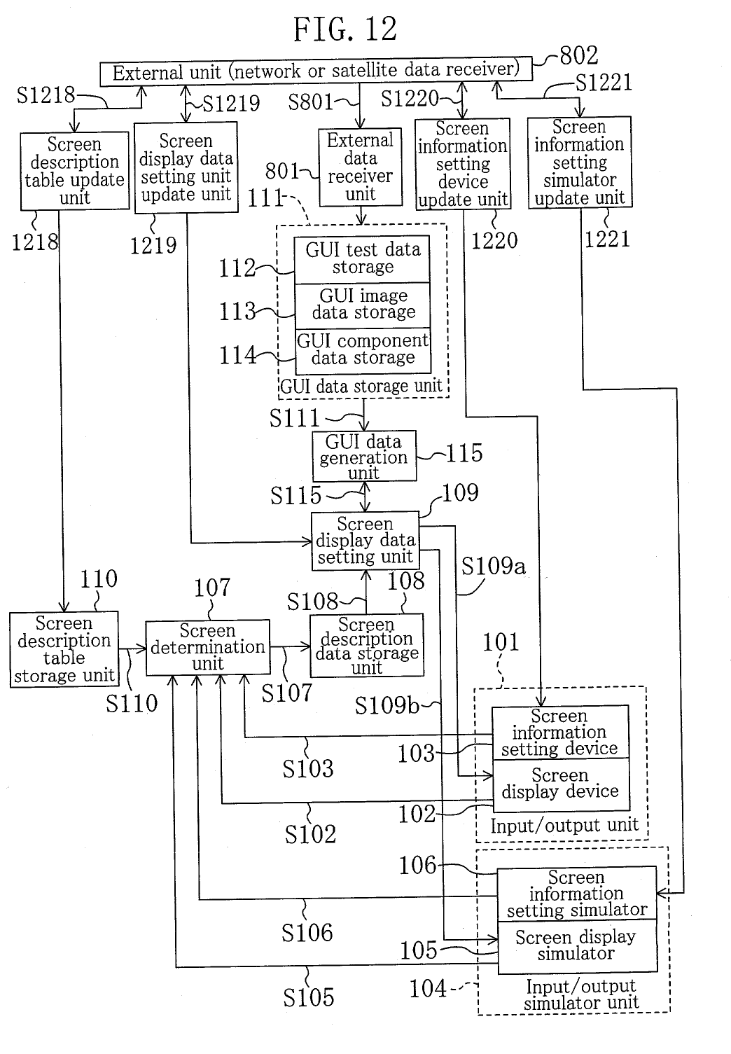

Embodiment 3 of the invention will now be described with reference to FIG. 12.

FIG. 12 is a block diagram for showing the structure of a display processor according to Embodiment 3 of the invention. In FIG. 12, like reference numerals are used to refer to like elements shown in FIGS. 1 and 8 so as to omit the detailed description. The display processor of FIG. 12 is different from those of FIGS. 1 and 8 in including a screen description table update unit 1218, a screen display data setting unit update unit 1219, a screen information setting device update unit 1220 and a screen information setting simulator update unit 1221.

The screen description table update unit 1218 receives new screen description table data S1218 sent through the external unit 802 such as a network or a satellite data receiver, and updates the screen description table storage unit 110 by processing, if necessary, the data S1218 into a format of the screen description table. The update may be requested by a user of the equipment or a provider of the equipment.

The screen display data setting unit update unit 1219 receives new data S1219 for the screen display data setting unit sent through the external unit 802, and updates the screen display data setting unit 109 by processing, if necessary, the data S1219 into a data format executable in the screen display data setting unit 109. The update may be requested by a user of the equipment or a provider of the equipment.

The screen information setting device update unit 1220 receives new data S1220 for the screen information setting device sent through the external unit 802, and updates the screen information setting device 103 by processing, if necessary, the data S1220 into a data format executable in the screen information setting device 103. The update may be requested by a user of the equipment or a provider of the equipment.

The screen information setting simulator update unit 1221 receives new data S1221 for the screen information setting simulator sent through the external unit 802, and updates the screen information setting simulator 106 by processing, if necessary, the data S1221 into a data format executable in the screen information setting simulator 106. The update may be requested by a user of the equipment or a provider of the equipment.

In this manner, this embodiment has not only the same function as that of Embodiment 1 and 2 but also the following function: Since the respective update units such as the screen description table update unit are additionally provided, the data stored in the display processor can be updated to the latest data or the respective units and devices can be updated to the latest specifications if necessary by issuing an update request by a user or a provider of the equipment through the external unit. Therefore, a new GUI screen can be generated by afterward changing the control of the GUI screen such as selection of GUI components and change of the sizes thereof in accordance with the characteristic and the operation mode of the equipment. As a result, more user friendly GUIs serving as a good user interface can be displayed. Also, in the case where there occurs any problem in the display processing of the GUI screen, the respective units and devices can be changed to attain the best operation specifications.

Although a TV is used as the input/output unit or the input/output simulator unit in all the aforementioned embodiments, the present invention can be similarly practiced by using any input/output unit having a function to display graphics, such as AV equipment other than a TV, a mobile telephone, a car navigation system and a personal computer.

What is claimed is:

1. A display processor comprising:
a screen display device for displaying graphics of GUIs;
a screen description table storage unit for storing a screen description table describing a displayable state corresponding to a characteristic and an operation mode of the screen display device;
a screen determination unit for acquiring screen characteristic data corresponding to the characteristic and the operation mode of the screen display device from the screen display device and, on the basis of the screen characteristic data, specifying, in the screen description table stored in the screen description table storage unit, screen description data corresponding to a state of the screen display device; and
a screen display data setting unit for setting, on the basis of the screen description data specified by the screen determination unit, screen display data to be displayed in the screen display device.

2. The display processor of claim 1, further comprising a screen information setting device for externally changing the characteristic and the operation mode of the screen display device,
wherein the screen determination unit acquires screen characteristic data corresponding to a characteristic and an operation mode of the screen display device having been changed by the screen information setting device and newly specifies screen description data corresponding to a state of the screen display device.

3. The display processor of claim 1, further comprising a GUI data storage unit for storing GUI component data used for screen display of the screen display device,
wherein the screen display data setting unit sets the screen display data on the basis of the GUI component data stored in the GUI data storage unit.

4. The display processor of claim 1,
wherein the screen description table storage unit has a structure in which the screen description table is updatable through an external unit such as a network or a satellite data receiver.

5. The display processor of claim 1,
wherein the screen display data setting unit has a structure in which an operation specification thereof is updatable through an external unit such as a network or a satellite data receiver.

6. The display processor of claim 2,
wherein the screen information setting device has a structure in which an operation specification thereof is updatable through an external unit such as a network or a satellite data receiver.

7. The display processor of claim 3,
wherein the GUI data storage unit has a structure in which the GUI component data is updatable through an external unit such as a network or a satellite data receiver.

8. The display processor of claim 1,
wherein the screen display data setting unit inputs the screen display data to a screen display simulator for verifying the GUIs, and
the screen display simulator switches a screen display mode thereof in accordance with the screen display data.
